(19) United States
(12) Patent Application Publication
(10) Pub. No.: US 2024/0044437 A1
(43) Pub. Date: Feb. 8, 2024

(54) PIPE INSPECTION DEVICES AND SYSTEMS, AND METHODS OF USING SAME

(71) Applicant: SABIC Global Technologies B.V., Bergen op Zoom (NL)

(72) Inventor: KHALID RAHIL SHELTAMI, Jubail (SA)

(21) Appl. No.: 18/258,719

(22) PCT Filed: Dec. 15, 2021
(86) PCT No.: PCT/IB2021/061790

§ 371 Date: Jun. 21, 2023

Related U.S. Application Data
(60) Provisional application No. 63/131,586, filed on Dec. 29, 2020.

(51) Int. Cl. F16L 55/44; G01N 29/14; G01N 29/24; G01N 29/265; F16L 55/48; F16L 55/32; G01N 22/02; G01N 29/04; H04N 7/18

(52) U.S. Cl. CPC F16L 55/44; G01N 29/14; G01N 29/2481; G01N 29/265; F16L 55/48; F16L 55/32; G01N 22/02; G01N 29/04; H04N 7/183; F16L 2101/30

(57) ABSTRACT

An unmanned vehicle can comprise a vehicle body configured to be at least partially submerged within liquid inside a conduit. At least one propeller can be coupled to the vehicle body. An actuator can be configured to effect movement of the at least one propeller to control motion of the unmanned vehicle within the liquid inside the conduit. A testing probe can be coupled to the vehicle body. The testing probe can optionally be an ultrasonic or microwave testing probe. An acoustic emission probe can be coupled to the vehicle body. A camera can be coupled to the vehicle body.

### CROSS-REFERENCE TO RELATED APPLICATION

This application claims priority to and the benefit of the filing date of U.S. Provisional Patent Application No. 63/131,586, filed Dec. 29, 2020, which is incorporated herein by reference in its entirety.

### FIELD

This disclosure is generally related to pipe inspection and, in particular, to unmanned vehicles that are deployed within pipes to permit inspection of the pipes.

### BACKGROUND

Fiber reinforced polymer (FRP) piping can be difficult to inspect. Main failures are commonly due to piping quality issues, soil settlement, and workmanship. FRP piping failures can result in substantial unplanned shutdowns and loss of revenue. Conventional inspection methods for buried piping require excavation at periodic lengths (e.g., every four meters) which is impractical. Accordingly, a devices, systems, and method of inspecting FRP piping form evaluation is desirable.

### SUMMARY

Described herein, in various aspects, is an unmanned vehicle. The unmanned vehicle can comprise a vehicle body configured to be at least partially submerged within liquid inside a conduit. At least one propeller can be coupled to the vehicle body. An actuator can be configured to effect movement of the at least one propeller to control motion of the unmanned vehicle within the liquid inside the conduit. A testing probe can be coupled to the vehicle body. The testing probe can optionally be an ultrasonic or microwave testing probe. An acoustic emission probe can be coupled to the vehicle body. A camera can be coupled to the vehicle body.

In one aspect, an unmanned vehicle can comprise a vehicle body configured to be at least partially submerged within liquid inside a conduit. At least one arm can be associated with the vehicle body and can be configured to be selectively deployed away from the vehicle body and toward an inner diameter of the conduit. Each arm of the at least one arm can comprise a distal end portion having a testing probe that is configured to contact the inner diameter of the conduit.

A system can comprise an unmanned vehicle and at least one processor that is communicatively coupled to the testing probe, the acoustic emission probe, and the camera. The at least one processor can be configured to receive and analyze outputs from the testing probe, the acoustic emission probe, and the camera to determine at least one condition of the pipe.

A method can comprise positioning an unmanned vehicle within a pipe so that the unmanned vehicle is at least partially submerged within liquid inside the pipe. At least one arm can be associated with the vehicle body. The testing probe can optionally be an ultrasonic or microwave testing probe. An acoustic emission probe can be coupled to the vehicle body. A camera can be coupled to the vehicle body. The at least one arm of the unmanned vehicle can be selectively deployed away from the vehicle body and toward an inner diameter of the pipe. Each arm of the at least one arm can comprise a distal end portion having a testing probe that contacts the inner diameter of the pipe. The testing probe can optionally be an ultrasonic or microwave testing probe. At least one processor can be used to receive and analyze outputs from the testing probe, the acoustic emission probe, and the camera to determine at least one condition of the pipe.

The unmanned vehicle can further comprise at least one propeller coupled to the vehicle body and an actuator configured to effect movement of the at least one propeller. The actuator can be used to control motion of the unmanned vehicle within the liquid inside the pipe.

### DESCRIPTION OF THE DRAWINGS

FIG. 1 is a schematic diagram of an unmanned vehicle in accordance with embodiments disclosed herein, disposed within a conduit and with arms in a retracted configuration.

FIG. 2A is a schematic diagram of the unmanned vehicle of FIG. 1, with the arms in a deployed configuration. FIG. 2B is a close-up view of a portion of the unmanned vehicle, showing an exemplary testing probe.

FIG. 3 is a schematic diagram of the unmanned vehicle of FIG. 1, disposed within a conduit.

FIG. 4 is a block diagram of an exemplary unmanned vehicle in accordance with embodiments disclosed herein.

FIG. 5 is a schematic diagram illustrating a system including an exemplary configuration of a computing device associated with the unmanned vehicle of FIG. 1.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a”, “an”, and “the” include plural referents unless the context clearly dictates otherwise. For example, use of the term “a propeller” or “an arm” can refer to one or more of such propellers or arms.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about” or “substantially,” it is contemplated that values within up to 15%, up to 10%, up to 5%, or up to 1% (above or below) of the particularly stated value or characteristic can be included within the scope of those aspects.

As used herein, the terms “optional” or “optionally” mean that the subsequently described event or circumstance may or may not occur, and that the description includes instances where said event or circumstance occurs and instances where it does not.

The word “or” as used herein means any one member of a particular list and, except where context indicates otherwise, can also include any combination of members of that list.

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

Disclosed herein are devices and systems that can inspect pipe (e.g., fiber-reinforced plastic (FRP) pipe or reinforced thermosetting resin (RTR) pipe) or other conduits. As used herein, unless the context indicates otherwise, the term “pipe” can be used to refer to a single pipe or to a plurality of pipes that cooperate to define a conduit or series of conduits. For example, in various aspects, the devices and systems can be used to quantitatively determine the remaining strength in pipe (e.g., FRP or RTR pipe) or another conduit, identify locations of leaks, and/or identify anomalies inside the pipe or other conduit. Embodiments disclosed herein can avoid requirements for confined space entry, excavation and down time. One or more subsequent inspections can be used to detect and determine any changes over time. Such changes over time can be used for predicting failures.

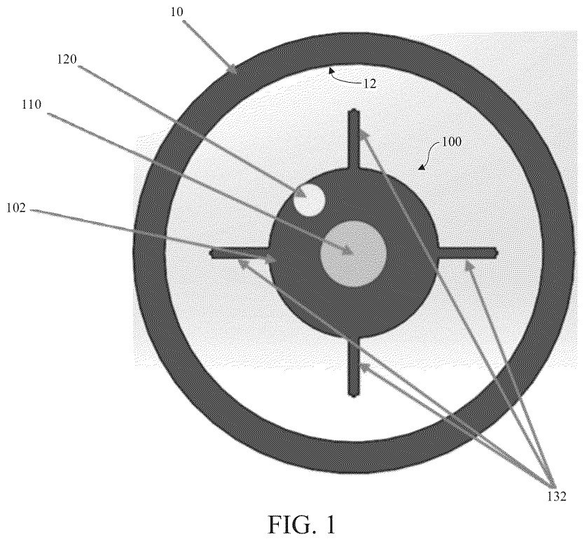

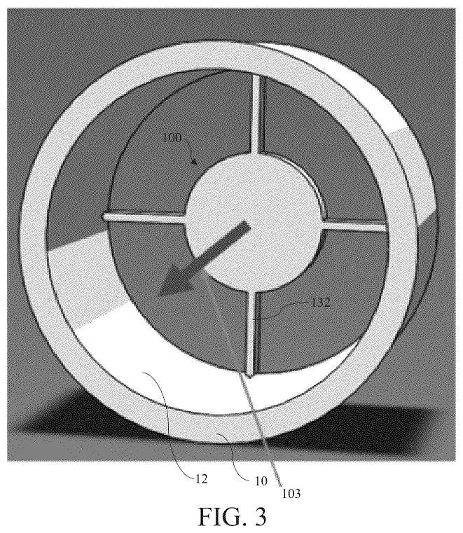

Referring to FIGS. 1-4, an unmanned vehicle 100 can be deployable into a conduit 10 (e.g., FRP pipe) having an inner wall 12. The unmanned vehicle 100 can comprise a vehicle body 102 that is configured to be at least partially submerged within liquid inside the conduit 10. The liquid in which the unmanned vehicle 100 can be deployed can include, for example, seawater, potable water, or cooling water. It is contemplated that the liquid can be (or comprise) various other liquids, such as, for example, ethylene glycol. The vehicle body 102 can have a central axis 103 that extends between a front and a rear of the vehicle body. It is contemplated that the unmanned vehicle 100 can be configured to move forward and, optionally, backward through the conduit 10.

The vehicle body 102 can be configured to maintain the unmanned vehicle 100 in an orientation so that the central axis of the vehicle body is generally parallel to (optionally, coaxial with, or within +/−15 degrees, within +/−10 degrees, within +/−5 degrees or within +/−1 degree of being parallel with) a central axis of the pipe/conduit 10. For example, the vehicle body 102 can have a length along the central axis 103 that is greater than the diameter of the pipe 10 in which the vehicle body is deployed. In this way, the vehicle body 102 can be inhibited from flipping relative to a transverse axis that is perpendicular to the central axis 103. Accordingly, in some aspects, the length of the vehicle body 102 can be greater than a maximum width of the vehicle body wherein the maximum width of the vehicle body is measured relative to any axis that is perpendicular to the central axis 103. In some optional aspects, the vehicle body 102 can have circular or rounded cross sections in planes perpendicular to the central axis 103. For example, in some aspects, at least a portion (or, optionally, an entirety) of the vehicle body 102 can be cylindrical. It is contemplated that a vehicle body 102 having circular cross sections can provide a maximum interior space for deployment into a cylindrical pipe. Optionally, the vehicle body 102 can have a shape like that of a submarine. For example, in some optional aspects, a front end of the vehicle body 102 can be pointed or rounded, (optionally, hemispherical or generally hemispherical), and a rear end of the vehicle body can be tapered.

In various aspects, the body 102 and/or various components of the unmanned vehicle 100 can comprise carbon fiber. In some optional aspects, the unmanned vehicle 100 can comprise low density structures (e.g., foam) and/or ballasts to balance the weight of the unmanned vehicle and/or to selectively modify the overall effective density of the unmanned vehicle. Optionally, the unmanned vehicle 100 can be neutrally buoyant.

At least one propeller 104 can be coupled to the vehicle body 102. Optionally, the at least one propeller 104 can be a single propeller. In further aspects, the at least one propeller 104 can comprise a plurality of propellers. In various aspects, the at least one propeller 104 can comprise a central propeller that is centrally positioned on the vehicle body 102 so that the central propeller rotates about the central axis 103. In further aspects, one or more propellers of the at least one propeller 104 can be radially offset from the central axis 103. The one or more radially offset propellers can rotate about respective axes that are optionally parallel to the central axis 103. In still further aspects, the at least one propeller 104 can comprise a plurality of propellers that are axially spaced along the length of the vehicle body 102.

An actuator 106 can be configured to effect movement of the at least one propeller 104 to control motion of the unmanned vehicle 100 within the liquid inside the conduit. In some optional aspects, the actuator 106 can be configured to rotate the propeller(s) 104 in a first rotational direction and in a second rotational direction that is opposite the first rotational direction. In further optional aspects, the propeller 104 can be configured to rotate in only one rotational direction. Accordingly, in some optional embodiments, the unmanned vehicle 100 can be configured to propel itself in a single direction (using the propeller 104), and the unmanned vehicle can then be retrieved via retraction of a cable that is coupled to the unmanned vehicle. In some aspects, the actuator 106 can comprise an electric motor. In some aspects, a respective actuator 106 can be configured to effect movement of each propeller 104. In further aspects, two or more propellers 104 can be actuated by one actuator 106.

A camera 110 can be coupled to the vehicle body 102. The camera 110 can be a high-resolution camera. The camera 110 can capture images of the interior of the pipe for analyzing pipe integrity. The camera 110 can further be used for navigational purposes. In some aspects, the camera can live-stream captured image data (e.g., wirelessly) to a remote monitor that is viewable by an operator. In further aspects, the camera 110 can be configured to collect and store image data for later retrieval.

An acoustic emission probe 120 can be coupled to the vehicle body 102. The acoustic emission probe 120 can be configured to detect acoustic waves traveling through the liquid in the conduit 10. Data from the acoustic emission probe 120 can provide leak information. For example, signals retrieved from the acoustic emission probe 120 can comprise acoustic data at one or more frequencies that are indicative of a leak in the conduit 10. In various aspects, the acoustic emission probe 120 or a computing device in communication therewith can apply a conventional algorithm (from known acoustic emission-based leak detection methods) to the acoustic data to detect a leak. For example, the acoustic signals at various locations can be compared. A leak can cause an acoustic emission that is not present at locations away from the leak. The acoustic signal at each location can be compared to one or more acoustic signals at other locations along the conduit. A location with an inconsistent acoustic signal can indicate a location of a leak. The acoustic signal of the non-leaking portion of the conduit can be a reference signal for a noise signal, and the acoustic signal at the location of leaking can be a sum of the noise signal and a leak signal. In some aspects, the frequency of sound excited by the leaking fluid, corresponding to the leak signal, can be calculated as f=V/(2d), where f is the frequency, V is the velocity of sound in the fluid in the conduit, and d is a diameter of a leak in the conduit. The acoustic emission probe 120 can optionally be made by MISTRASS GROUP, INC. or VALLEN.

At least one testing probe 130 can be coupled to the vehicle body 102. For example, in some optional aspects, a single testing probe 130 can be coupled to the vehicle body. That is, in these aspects, the at least one testing probe 130 can consist of a single testing probe 130. In further aspects, a plurality of testing probes 130 can be coupled to the vehicle body. Optionally, in some aspects, a plurality of testing probes 130 can be circumferentially spaced (optionally, equally circumferentially spaced) around the vehicle body 102. For example, the unmanned vehicle 100 can comprise four circumferentially spaced testing probes 130. The testing probes 130 can comprise ultrasonic transducers and/or microwave testing probes. For example, some of the testing probes 130 can be ultrasonic transducers, and some of the testing probes 130 can be microwave testing probes. In further aspects, all of the testing probes 130 can be microwave testing probes, or all of the testing probes can be ultrasonic transducers. It is contemplated that ultrasonic signals can be indicative of a flexural modulus, and the flexural modulus can be converted to a stiffness. For example, using a longitudinal wave and a shear wave transducer, respective longitudinal and shear velocities V_{L} and V_{T} can be measured as thickness/(round trip transit time/2). Poisson's ratio, ν, can be calculated as [1−2*(V_{T}/V_{L})²]/[2-2*(V_{T}/V_{L})²]. The flexural modulus can then be calculated as V_{L}²*ρ(1+ν)(1−2ν)/(1−ν). The stiffness can be compared with the design strength of the piping (conduit material) to detect degradation. It is contemplated that microwave signals can operate on the basis of leading and lagging probes. A crossing between signals of the leading and lagging probes can be indicative of potential weaknesses in the piping (conduit). Optionally, the testing probes can comprise OLYMPUS ultrasonic or microwave probes.

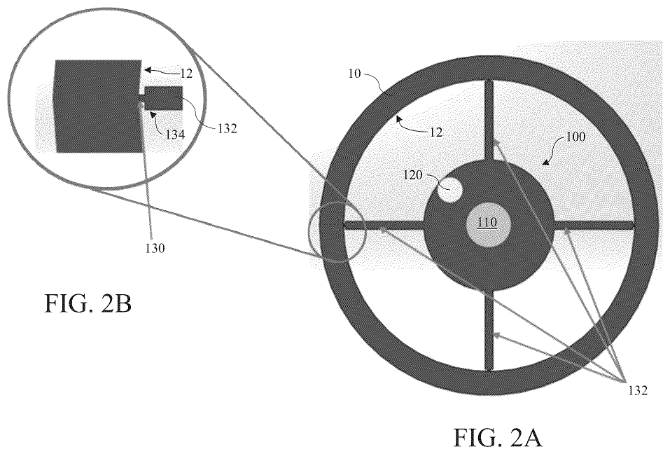

In some aspects, testing probes 130 can be movable from a retracted position to a deployed position. For example, each testing probe 130 can be coupled to a respective arm 132. Each arm 132 can be associated with the vehicle body 102 and can be configured to be selectively deployed away from the vehicle body 102 and toward the inner wall 12 (inner diameter) of the conduit 10. Each testing probe 130 can be coupled to a distal end 134 of a respective arm 132. When in a deployed position, testing probe 130 can be in contact with the inner wall 12 (inner diameter) of the conduit 10. Optionally, a testing probe actuator 138 can effect movement of the arms 132 about and between the deployed position (FIGS. 2A-2B) and a retracted position (FIG. 1). In some optional aspects, the testing probe actuator 138 can be a linear actuator. In further optional aspects, the arms 132 can be pivotally coupled to the vehicle body 102, and the arms can rotate about respective pivotal axes about and between the deployed and retracted positions. In some optional aspects, when in the retracted position, the arms 132 can be at least partially received within the vehicle body 102. For example, the vehicle body 102 can define respective holes through which the arms can extend. In some optional aspect, the arms 132 can be telescoping. In some optional aspects, the arms 132 can be actuated pneumatically. The arms 132 can be configured to bias against the inner walls of the conduit, optionally, with a pressure of less than 14 psi. The arms 132 can optionally expand to up to at least 25 inches in length (optionally, up to about 28 inches in length). In this way, the probes 130 on opposing arms 132 can extend to at least 50 inches from each other (optionally, up to about 56 inches from each other).

Optionally, the arms 132 can engage the inner wall 12 of the conduit 10 to hold the unmanned vehicle 100 in position for testing. In further aspects, the unmanned vehicle 100 can move with the arms biasing against the inner wall 12 of the conduit 10 so that the unmanned vehicle can scan along the length of the conduit.

The unmanned vehicle 100 can comprise at least one positioning device. For example, the unmanned vehicle can comprise a global positioning system (GPS) module 140, which can include a GPS receiver or other conventional components for receiving position information from GPS satellites as is known in the art. In this way, the location of the unmanned vehicle 100 can be determined. It is contemplated that the data collected by the data capture equipment (e.g., the camera 110, the acoustic emission probe 120, and the testing probes 130) can be associated with respective locations determined by the GPS module 140. In this way, the location of any anomalies in the conduit can be determined. In various aspects, the unmanned vehicle can comprise an inertial measurement unit (IMU). Optionally, the IMU can be used for dead reckoning, which can complement GPS data to improve the accuracy of the location determination of the unmanned vehicle 100. In further aspects, the IMU can be used to determine orientation of the unmanned vehicle.

The unmanned vehicle 100 can comprise a power source 150 (e.g., one or more batteries) or an umbilical cable. The power source 150 can be configured to provide power to the actuator(s) 106 and the testing probe actuators 138, as well as to the data capture equipment such as, for example, the camera 110, the acoustic emission probe 120, and the testing probes 130. The power source 150 can further be configured to provide power to a computing device 1001, as disclosed herein. The umbilical cable can further be used for wired data transfer.

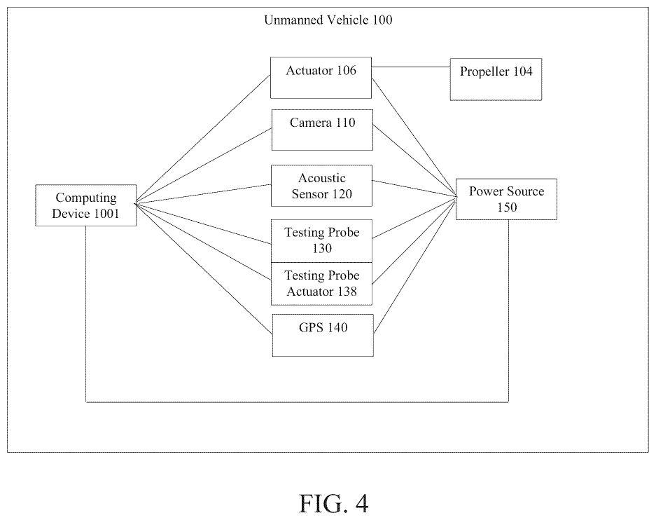

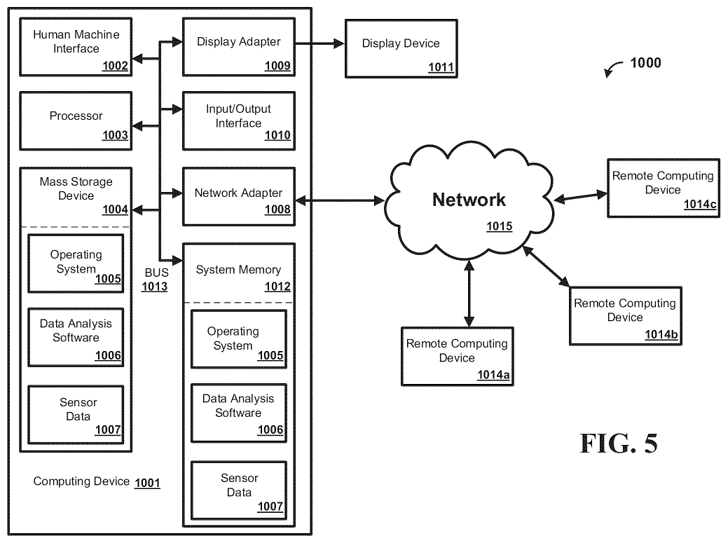

With reference to FIGS. 4-5, the unmanned vehicle 100 can comprise or be communicatively coupled to a computing device 1001. The computing device 1001 can be configured to receive outputs from the data capture equipment (e.g., the camera 110, the acoustic emission probe 120, and the testing probes 130). In further aspects, computing device 1001 can be configured to collect and log data captured by the data capture equipment. The computing device 1001 can further be configured to associate the data from each of the data capture equipment. The data can further be associated with other parameters, such as GPS location or data collection time.

The computing device 1001 can optionally be configured to at least partially control movement of the unmanned device. The computing device 1001 can be configured to interface with one or more remote computing devices for receiving control inputs (e.g., control of the actuators 106 or testing probe actuators 138, control inputs that initiate/halt data collection of the data capture equipment) as well as providing outputs (e.g., raw data output or output of processed data).

Optionally, the computing device 1001 or a remote computing device can further be configured to analyze the data from the data capture equipment, as further described herein. For example, the computing device 1001 or the remote computing device can, using one or more processors, receive outputs from at least one of the testing probe, the acoustic emission probe, or the camera and analyze said outputs to determine at least one condition of the pipe. The condition can be, for example, a detection of an anomaly (e.g., a leak, a crack, a thin wall, or corrosion), a parameter (e.g., strength or wall thickness) or a change in a parameter of the pipe, a predicted remaining lifetime, or an abnormal object in the conduit. For example, conventional image-processing algorithms can be used to analyze camera images to detect wear, cracks, or an abnormality in the conduit, such as an unusual object in the conduit (e.g., pieces of metal, sand, etc.). Similarly, conventional algorithms, such as those described further herein, can be used to analyze ultrasonic transducer waves. In further aspects, an operator can manually or automatically inspect and analyze image data, ultrasonic data, and/or acoustic emission probe data. Optionally, the computing device 1001 or the remote computing device can compare data from the data capture equipment that is collected at different times spaced by a time interval (e.g., one month apart, one year apart, etc.) and determine changes in the conduit over the time interval. The computing device 1001 or the remote computing device can be further configured to determine, based on the changes over the time interval, a rate of change and, optionally, a predicted life expectancy. For example, the computing device 1001 or the remote computing device can recommend repair or replacement of the pipe after a calculated duration.

A common failure of piping such as FRP piping is a loss of strength rather than thinning. Cameras can be inadequate to conclusively detect weaknesses in piping (e.g., FRP piping). Accordingly, the combination of the data collected by the various sensors and probes of the unmanned vehicle, as disclosed herein, can proved a more complete understanding of the condition of the conduit. Further, in liquids such as ethylene glycol, it is contemplated that images from the camera, as disclosed herein, can be at least partially obstructed, yet data captured by other means (e.g., acoustic and microwave/ultrasonic data) can still provide data for inspecting the conduit to determine the conduit health and detect anomalies. Moreover, for buried piping, determination of leak location can be critical to stop the leak. Particularly in geographical locations where the water table is high, the observed leak above ground can be tens of meters away from the pipe leak location. Accordingly, leak detection, such as that which can be detected with the acoustic emission probe, in combination with known position of the unmanned vehicle 100, can be advantageous in pinpointing the leak. For seawater piping, it can be common to find foreign objects in the conduit due to filtering failure. Accordingly, the camera, optionally in combination with smart data analytics to detect such foreign objects, can be advantageous. Still further, the unmanned vehicle 100 enables inspection of pipe strength from inside the conduit, thereby eliminating the need for excavation and risking damage to the conduit. Thus, the combination of non-destructive testing means disclosed herein, in addition to the other disclosed features of the unmanned vehicle 100, provide robust knowledge of the condition of the conduit, and can do so with a single deployable unit.

### The Computing Device

FIG. 5 shows a system 1000 including an exemplary configuration of the computing device 1001. In various optional aspects, the computing device 1001 can comprise portions that are associated with the unmanned vehicle 100 and other portions that are associated with a remote device that is in communication with the unmanned vehicle.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as sensor data 1007 and/or program modules such as operating system 1005 and data analysis determining software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and data analysis software 1006 may be stored on the mass storage device 1004. One or more of the operating system 1005 and data analysis software 1006 (or some combination thereof) may comprise program modules and the data analysis software 1006. Sensor data 1007 (e.g., camera and probe data) may also be stored on the mass storage device 1004. The sensor data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various optional aspects, for example, the remote computing device 1014a can be a computing device that interfaces with unmanned vehicle 100 for providing data to the operator and, optionally, enabling the operator to control the device (e.g., movement of the unmanned vehicle, initiation of data collection, deployment/retraction of the arms 132, etc.). In further optional aspects, the remote computing device 1014b can be a server that receives and stores logged data from the remote device.

Application programs and other executable program components such as the operating system 1005 are shown herein as discrete blocks, although it is recognized that such programs and components may reside at various times in different storage components of the computing device 1001, and are executed by the one or more processors 1003 of the computing device 1001. An implementation of data processing software 1006 may be stored on or sent across some form of computer readable media. Any of the disclosed methods may be performed by processor-executable instructions embodied on computer readable media.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.
Aspect 1: An unmanned vehicle comprising:
a vehicle body having a central axis, wherein the vehicle body is configured to be at least partially submerged within liquid inside a conduit;
at least one testing probe coupled to the vehicle body, wherein the at least one testing probe is an ultrasonic or microwave testing probe;
an acoustic emission probe coupled to the vehicle body; and
a camera coupled to the vehicle body.
Aspect 2: The unmanned vehicle of aspect 1, further comprising:
at least one propeller coupled to the vehicle body;
an actuator configured to effect movement of the at least one propeller to control motion of the unmanned vehicle within the liquid inside the conduit.
Aspect 3: The unmanned vehicle of aspect 2, wherein the at least one propeller is coaxial with the central axis of the vehicle body.
Aspect 4: The unmanned vehicle of any one of aspects 1-3, further comprising:
at least one arm associated with the vehicle body and configured to be selectively deployed away from the vehicle body and toward an inner diameter of the conduit,
wherein each arm of the at least one arm comprises a distal end portion having a testing probe that is configured to contact the inner diameter of the conduit,
wherein each arm of the at least one arm comprises a distal end portion having a respective testing probe of the at least one testing probe that is configured to contact the inner diameter of the conduit.
Aspect 5: The unmanned vehicle of aspect 4, further comprising at least one actuator that is operatively coupled to a respective arm of the at least one arm, wherein the at least one actuator is configured to move the respective arm about and between a retracted position and a deployed position in which the at least one testing probe is in contact with the inner diameter of the conduit.
Aspect 6: The unmanned vehicle of aspect 5, wherein the at least one actuator comprises a linear actuator that is configured to move the at least one arm radially outwardly from the central axis.
Aspect 7: The unmanned vehicle of any one of aspects 1-6, wherein the vehicle body has a length along the central axis, wherein the length of the vehicle body is greater than a maximum width of the vehicle body wherein the maximum width of the vehicle body is measured relative to any axis that is perpendicular to the central axis.
Aspect 8: The unmanned vehicle of any one of aspects 1-7, further comprising a global positioning system (GPS) module.
Aspect 9: A pipe analysis system comprising:
an unmanned vehicle according to any one of aspects 1-8; and
at least one processor that is communicatively coupled to the testing probe, the acoustic emission probe, and the camera, wherein the at least one processor is configured to receive and analyze outputs from the testing probe, the acoustic emission probe, and the camera to determine at least one condition of the pipe.
Aspect 10: The pipe analysis system of aspect 9, wherein the at least one processor is physically associated with the unmanned vehicle.
Aspect 11: The pipe analysis system of aspect 9, wherein the at least one processor is physically associated with a remote computing device that is in communication with the unmanned vehicle.
Aspect 12: The pipe analysis system of aspect 11, wherein the remote computing device is further configured to receive operator input.
Aspect 13: The pipe analysis system of any one of aspects 9-12, wherein the unmanned vehicle comprises a GPS module that is in communication with the at least one processor, wherein the at least one processor is configured to associate data from each of the camera, the acoustic emission probe, and the at least one testing probe with a corresponding location at which the data was collected.
Aspect 14: The pipe analysis system of any one of aspects 9-13, further comprising:
at least one propeller coupled to the vehicle body;
an actuator configured to effect movement of the at least one propeller to control motion of the unmanned vehicle within the liquid inside the conduit.
Aspect 15: The pipe analysis system of aspect 14, further comprising a remote computing device in communication with the unmanned vehicle, wherein the remote computing device is configured to receive operator input and, in response to receiving the operator input, cause the actuator to effect movement of the at least one propeller.
Aspect 16: The pipe analysis system of aspect 15, wherein the remote computing device is in communication with a display device, wherein the remote computing device is further configured to receive image data from the camera of the unmanned vehicle and display the image data on the display device.
Aspect 17: The pipe analysis system of any one of aspects 9-16, further comprising at least one actuator that is operatively coupled to a respective arm of the at least one arm, wherein the at least one actuator is configured to move the respective arm about and between a retracted position and a deployed position in which the at least one testing probe is in contact with the inner diameter of the conduit.
Aspect 18: A method comprising:
positioning an unmanned vehicle of any one of aspects 1-8 within a conduit, the unmanned vehicle being at least partially submerged within liquid inside the conduit;
receiving, by at least one processor, outputs from the testing probe, the acoustic emission probe, and the camera; and
analyzing, by the at least one processor, the outputs to determine at least one condition of the conduit.
Aspect 19: The method of aspect 18, further comprising: selectively deploying the at least one arm of the unmanned vehicle away from the vehicle body and toward an inner diameter of the conduit, wherein each arm of the at least one arm comprises a distal end portion having a testing probe that contacts the inner diameter of the conduit, wherein the testing probe is an ultrasonic or microwave testing probe.
Aspect 20: The method of aspect 18 or aspect 19, wherein the unmanned vehicle further comprises at least one propeller coupled to the vehicle body and an actuator configured to effect movement of the at least one propeller, and wherein the method further comprises:
controlling, by the actuator, motion of the unmanned vehicle within the liquid inside the pipe.

Although the foregoing invention has been described in some detail by way of illustration and example for purposes of clarity of understanding, certain changes and modifications may be practiced within the scope of the appended claims.

1. An unmanned vehicle comprising:
a vehicle body having a central axis, wherein the vehicle body is configured to be at least partially submerged within liquid inside a conduit;
at least one testing probe coupled to the vehicle body, wherein the at least one testing probe is an ultrasonic or microwave testing probe;
an acoustic emission probe coupled to the vehicle body; and
a camera coupled to the vehicle body.

2. The unmanned vehicle of claim 1, further comprising:
at least one propeller coupled to the vehicle body;
an actuator configured to effect movement of the at least one propeller to control motion of the unmanned vehicle within the liquid inside the conduit.

3. The unmanned vehicle of claim 2, wherein the at least one propeller is coaxial with the central axis of the vehicle body.

4. The unmanned vehicle of claim 1, further comprising:
at least one arm associated with the vehicle body and configured to be selectively deployed away from the vehicle body and toward an inner diameter of the conduit,
wherein each arm of the at least one arm comprises a distal end portion having a testing probe that is configured to contact the inner diameter of the conduit,
wherein each arm of the at least one arm comprises a distal end portion having a respective testing probe of the at least one testing probe that is configured to contact the inner diameter of the conduit.

5. The unmanned vehicle of claim 4, further comprising at least one actuator that is operatively coupled to a respective arm of the at least one arm, wherein the at least one actuator is configured to move the respective arm about and between a retracted position and a deployed position in which the at least one testing probe is in contact with the inner diameter of the conduit.

6. The unmanned vehicle of claim 5, wherein the at least one actuator comprises a linear actuator that is configured to move the at least one arm radially outwardly from the central axis.

7. The unmanned vehicle of claim 1, wherein the vehicle body has a length along the central axis, wherein the length of the vehicle body is greater than a maximum width of the vehicle body wherein the maximum width of the vehicle body is measured relative to any axis that is perpendicular to the central axis.

8. The unmanned vehicle of claim 1, further comprising a global positioning system (GPS) module.

9. A pipe analysis system comprising:
an unmanned vehicle according to claim 1; and
at least one processor that is communicatively coupled to the testing probe, the acoustic emission probe, and the camera, wherein the at least one processor is configured to receive and analyze outputs from the testing probe, the acoustic emission probe, and the camera to determine at least one condition of the pipe.

10. The pipe analysis system of claim 9, wherein the at least one processor is physically associated with the unmanned vehicle.

11. The pipe analysis system of claim 9, wherein the at least one processor is physically associated with a remote computing device that is in communication with the unmanned vehicle.

12. The pipe analysis system of claim 11, wherein the remote computing device is further configured to receive operator input.

13. The pipe analysis system of claim 9, wherein the unmanned vehicle comprises a GPS module that is in communication with the at least one processor, wherein the at least one processor is configured to associate data from each of the camera, the acoustic emission probe, and the at least one testing probe with a corresponding location at which the data was collected.

14. The pipe analysis system of claim 9, further comprising:
at least one propeller coupled to the vehicle body;
an actuator configured to effect movement of the at least one propeller to control motion of the unmanned vehicle within the liquid inside the conduit.

15. The pipe analysis system of claim 14, further comprising a remote computing device in communication with the unmanned vehicle, wherein the remote computing device is configured to receive operator input and, in response to receiving the operator input, cause the actuator to effect movement of the at least one propeller.

16. The pipe analysis system of claim 15, wherein the remote computing device is in communication with a display device, wherein the remote computing device is further configured to receive image data from the camera of the unmanned vehicle and display the image data on the display device.

17. The pipe analysis system of claim 9, further comprising at least one actuator that is operatively coupled to a respective arm of the at least one arm, wherein the at least one actuator is configured to move the respective arm about and between a retracted position and a deployed position in which the at least one testing probe is in contact with the inner diameter of the conduit.

18. A method comprising:
positioning an unmanned vehicle of claim 1 within a conduit, the unmanned vehicle being at least partially submerged within liquid inside the conduit; and
receiving, by at least one processor, outputs from the testing probe, the acoustic emission probe, and the camera; and
analyzing, by the at least one processor, the outputs to determine at least one condition of the conduit.

19. The method of claim 18, further comprising:
selectively deploying the at least one arm of the unmanned vehicle away from the vehicle body and toward an inner diameter of the conduit, wherein each arm of the at least one arm comprises a distal end portion having a testing probe that contacts the inner diameter of the conduit, wherein the testing probe is an ultrasonic or microwave testing probe.

20. The method of claim 18, wherein the unmanned vehicle further comprises at least one propeller coupled to the vehicle body and an actuator configured to effect movement of the at least one propeller, and wherein the method further comprises:
controlling, by the actuator, motion of the unmanned vehicle within the liquid inside the pipe.
